(19) United States
(12) Patent Application Publication
(10) Pub. No.: US 2016/0292143 A1
(43) Pub. Date: Oct. 6, 2016

(54) SYSTEM AND METHOD FOR AUTOMATED ONLINE WIZARD GENERATION

(71) Applicant: RTO Benefits, LLC, Lenexa, KS (US)

(72) Inventor: Michael Ross RAMETTA, Kansas City, MO (US)

(21) Appl. No.: 15/089,374

(22) Filed: Apr. 1, 2016

Related U.S. Application Data
(60) Provisional application No. 62/141,704, filed on Apr. 1, 2015.

(51) Int. Cl. G06F 17/24; G06F 17/22; G06F 17/30; G06F 9/44

(52) U.S. Cl. CPC G06F 17/243; G06F 9/4446; G06F 17/2247; G06F 17/30896; G06F 17/30339; G06F 17/30085

(57) ABSTRACT

Systems and method are provided for quickly and efficiently creating and maintaining an online wizard with a save-and-return-to-complete capability. A markup page is created and includes certain markers that enable the system to automatically generate, based on the markers, the components of the wizard, including field validators, database table operations and query commands, and server-side code. The systems and methods further automatically generate components of the wizard to enable a user to save progress and return later to complete the data entry.

### CROSS-REFERENCE TO RELATED APPLICATIONS

This application is a non-provisional application and claims priority of U.S. Provisional Application No. 62/141,704, filed Apr. 1, 2015, entitled “System and Method for Facilitating Multiple Brand Hosting, which is herein incorporated by reference in its entirety

### FIELD OF THE INVENTION

The present invention relates generally to methods of and systems for quickly and efficiently creating and maintaining an online wizard, and more particularly, the present invention relates generally to methods of and systems for quickly and efficiently creating and maintaining an online wizard with save-and-return-to-complete capability.

### BACKGROUND

In traditional systems, there is a lengthy process in order to create and maintain an online wizard or a tool with save-and-return-to-complete capability. A wizard or tool with such capability consists of creating a user interface, such as HTML pages with form fields, for the user to enter information or data where the user may enter some data and return later to complete the data entry. First, a database table must be created to house the data where each field in the interface needs a matching field in the database. Creating the user interface requires the development of HTML (Hyper Text Markup Language) and CSS (Cascading Style Sheets). Ideally, for streamlined entry, field validations to make sure the form is filled in correctly should occur before a user submits the wizard page. Currently, such systems would require JavaScript development. Further, separate calls to the database may be required to validate that there is no duplication of data. In order for that to occur prior to posting data, AJAX (Asynchronous JavaScript and XML) is required. In order to use the data posted to a server, some form of server side code is required to take that posted data, validate it, and then send it to a database. This could be PHP, .NET, Ruby, JAVA, PERL, Python, or any other server-side language. To store the data and operate on it, some database or object query language is required. For example PHP and MySQL could serve as the server and database language, respectively.

Each new page of the wizard would require not just UI development but also alterations to each of the code bases and data structures. Entirely new wizards would most likely require new databases or database tables to be created and new methods and classes to access them. Individual queries for each page would need to be written to display previously entered data by the user in the appropriate fields. This means that each new wizard could require hundreds of man-hours of development and testing.

### SUMMARY

The present invention addresses these and other drawbacks by using the highest level and simplest language in the group to enable the wizard system to generate required components. In accordance with embodiments of the present invention, an HTML markup page is created, and the system automatically generates the rest of the required components based on that HTML page, including components such as JavaScript validators, AJAX validators, database table creation, server code (PHP) and MySQL query code. A CSS class is applied to the HTML page to format the HTML objects, such as anchor tags, td (table cell), or hl (heading) tags into the desired style. Data may be inputted into the HTML markup page via a user interface. JavaScript then reads the HTML for markers to determine if a form field is present, and what type of field it is. The rules and responses to the various field types are auto generated based on the field attributes. The auto-generation is accomplished by having a JavaScript class read all the form fields in the HTML DOM (Document Object Model) and look for an attribute tag to tell it which validator to apply to that field.

In accordance with one embodiment of the invention, the possible form field types comprise:
Date
Time
Date Time
Zip Code
Phone Number
E-mail
URL (Uniform Resource Locator)
integer
credit card
bank account number
routing number
none
custom
currency
decimal
SSN (Social Security Number)
EIN (Employer Identification
IP (Internet Protocol) address
Multi Select (checkboxes)
Text Area for large input
HTML input for formatted text
Single Select (radio buttons)
Single Select (list)
Single Select Binary
Un-ordered free form lists (array generation)
Required unique (AJAX)
   In addition, the validators that are applied to each of the above fields are active states which monitor key presses to block the input of inappropriate values. For example, because there are no alpha or special characters permitted in fields expecting integer values, when a user presses the “s” key in an integer field, the key press is blocked and no character will appear. The validators are able to automatically correct specific format separators that are not required for data entry. For example, if Jan. 15, 2013 needed to be formatted as 01-15-2013, the user would not need to enter the specific separators. The script automatically corrects, so that a keyed entry could be 01152013 or 01.15.2013, and the returned value would still be 01-15-2013. All validators can include active state monitoring to enable such auto-correction.

In accordance with another embodiment of the invention, database automation is utilized in establishing the online wizard with save-and-return-to-complete capability. An HTML page is created and the remaining components of the system, including JavaScript and AJAX validators, are automatically generated based on the HTML page. Data is inputted in the HTML pages via a user interface, and a CSS class is used to format and style the user interface. The HTML pages contain information that enables the system to determine if new table columns (also called fields) or new database tables are required. In one embodiment, server code on the system determines whether new columns or tables need to be created based on a series of hidden input fields in the HTML page. If the server-side code determines that the field does not exist in the database table in the database, the code issues a database statement to alter the database table to create a new field within the table. If the server-side code determines that the field already exists in the database table, the code would check to see if a record for the field already exists. The hidden inputs correlate to the table's keys, and in one embodiment, the inputs correspond to a foreign key field called “userid” and to a primary key field called the “id”. In that embodiment, if a foreign key exist in the database table that corresponds to the “userid” value in the hidden inputs, then a record exists and an update command is issued to update the record with the values in the form fields of the HTML page. Otherwise, if no record exists, then an insert command is issued to insert a new record would be created.

In accordance with another embodiment of the invention, a wizard module is set up to further facilitate the save-and-return-to-complete capability and process. Each wizard has its own folder in a wizards directory of the server. The folder contains the HTML pages needed to drive the database automation process. The folder name is the same as the database table name it correlates to. This is a security measure to ensure that no operations are being generated by unauthorized users and to prevent errors in the code from creating unwanted databases. In one embodiment, a naming convention for a database table, its primary key field, and the foreign key field is established to enable the automatic generation of the primary key field and the foreign key field when the database table is first created. In one example, at the time of table creation, both the primary and foreign key fields are created automatically and the names of both keys are generated based on the table name. The file name of the HTML pages determine the order and progress of presented wizard pages as well as “Next” and “Previous” buttons and a progress bar displayed on the HTML page. For example, HTML pages are named as follows in folder tb1: page1, page2, page3, page4.

In an embodiment, when an HTML page of the wizard is requested, a server-side script looks at the total number of files in the containing folder and then divides the current page number by the total to determine its progress-meter display. The script determines if it's on the first or last page of the wizard by counting the files and comparing with the current page number. If it's the first page, no “Previous” button is added to the HTML page, and if it's the last page, no “Next” button is added and instead a “Finish” button is added to the HTML page. Then, the user interface—the automatically generated HTML page—is presented to a user, who may input data into the page. The validators in the HTML page that validate the inputted data, may include JavaScript validators, some of which are active state monitors, and AJAX validators. Whenever the user presses the “Next”, “Previous”, or “Finish” button (as the case may be) in the HTML page user interface, the page is posted to the server. The inputted data may be checked again by validators at the server-side. Based on hidden input fields in the HTML page, the system determines the correct table in which to store the inputted data, and determines if it is a new record or an update to an existing record. If a new record, an insert command is created, and if a record already exists, an update command is created. When the wizard reaches the final page of the folder, a review page is then generated to show all of the prompts previously presented and the user's inputted data in response to the prompts. The user can jump back to any of the previous sections and edit user inputted data before completing the process. The process is completed by pressing submit at the end of the wizard.

In accordance with another embodiment of the invention, data retention for returning users to the online wizard is established. An HTML markup page is created and the rest of the system self-generates based on the HTML markup page. Data is inputted in the HTML markup pages via a user interface, and then data is stored by a combination of user id and record identifier for each wizard in a wizard-specific table in a database. Each user on the system is issued a unique id. Each user is assigned only 1 record per wizard. This is to allow version control as well as simple look-ups to retrieve data previously entered into a wizard (whether complete or incomplete). Every table has a field called “farthest completed,” which is the farthest completed page by the user. When the user returns to the site, he will be automatically directed to that page. A combination of JavaScript, server-side code, MySQL, and HTML attributes determines if any data needs to be inserted into the page, and inserts such data without causing JavaScript errors for missing items. A mass query is then generated based on the folder requesting the query once the user returns to the site/wizard. Next the server-side code injects JavaScript into the HTML page to update the field values of known fields in the HTML DOM. The server-side code generates JavaScript to read the page for hidden html fields called special fields. In the item's value attribute is a text array of the associated field types and their requirements. These features ensure that no additional server-side code needs to be written for the addition of new wizard pages or for updates to existing ones. All the possible properties validators and display formatters are already in place.

In accordance with another embodiment of the invention, creating and maintaining an online wizard with save-and-return-to-complete capability comprises a computing device that comprises a processor coupled to a computer readable storage medium including computer executable instructions. Upon execution of the instructions, an HTML page is created, and based upon the created HTML page, components necessary for the wizard is automatically generated. A database table is automatically created if necessary, and database commands are automatically generated, all based on the HTML page. A wizard module is set up with each wizard having its own folder in a wizards directory of a server. Each folder contains the HTML pages needed to drive the database automation process. A review page is generated to show users all of the questions they answered and how they answered them. Data retention capability for returning users is established, allowing users to save their data/progress and return back at a later time and bring up their saved data/progress. After reviewing and going back if needed to make any edits, finish and submit options can be selected.

### BRIEF DESCRIPTION OF THE DRAWINGS

The drawings constitute a part of this specification and include exemplary embodiments of the disclosed subject matter and illustrate various objects and features thereof.

FIG. 1 is a flow diagram for creating and maintaining an online wizard with save-and-return-to-complete process.

FIG. 2 is a table of form field/validator types for use with the wizard's HTML pages.

FIG. 3 is a table of options that further specify the behavior of a date validator.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

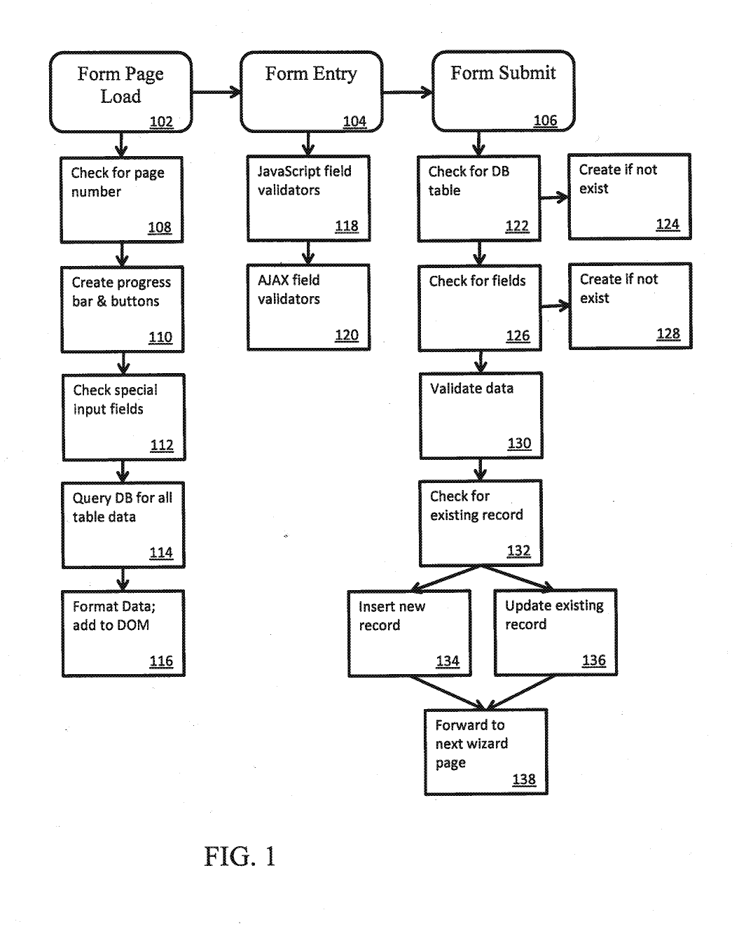

Referring to the drawings, FIG. 1 illustrates the process flow of an embodiment of the disclosed subject matter—a method for creating and maintaining an online wizard with save-and-return-to-complete capability. An online wizard comprises a user interface that presents information collection forms to a user. The user interface may comprise a series of web pages, for example, and is designed to collect input data from the user in response to the forms. A wizard with a save-and-return-to-complete ability enables the user to enter some data and return later to complete the data entry.

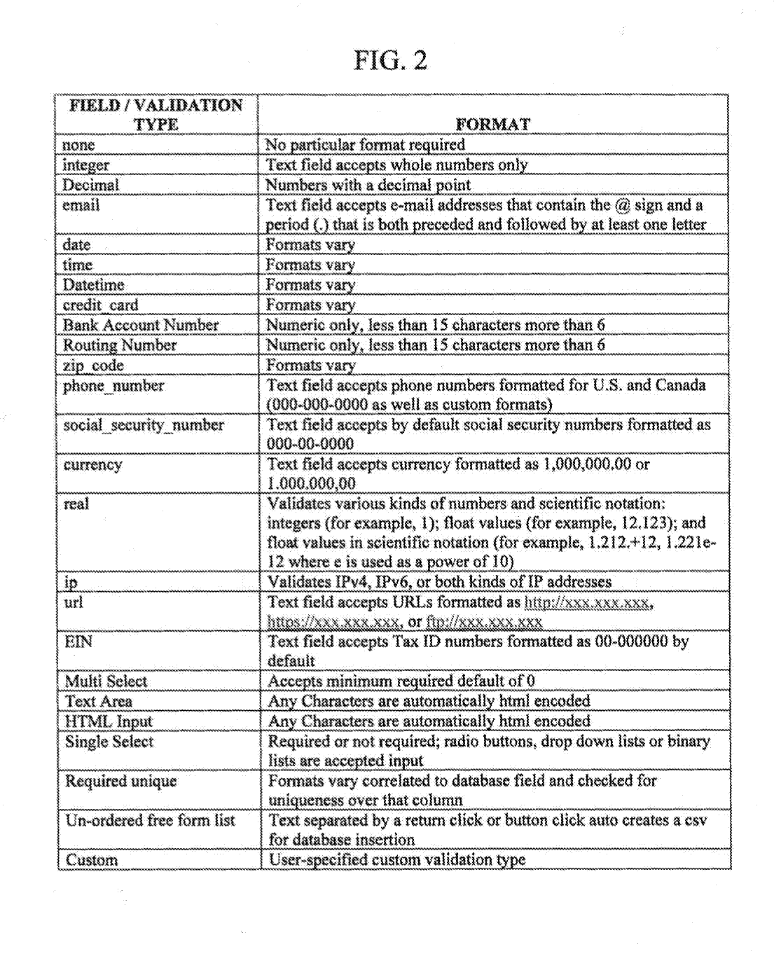

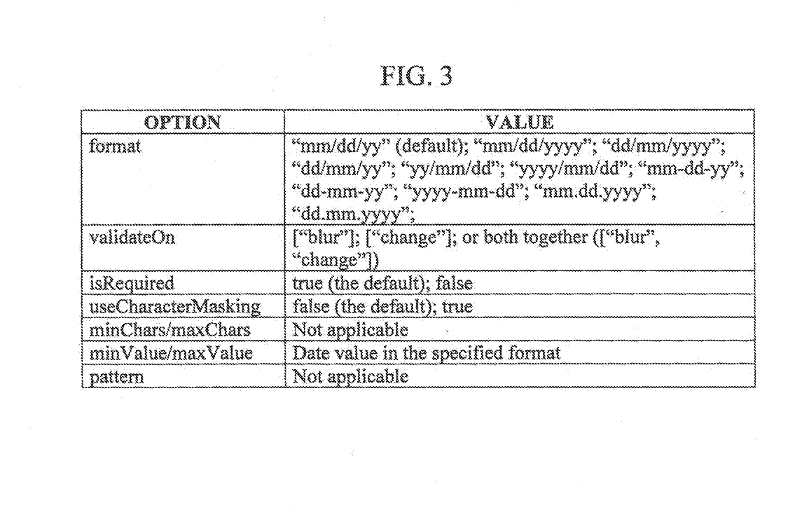

In one embodiment, a method performed by a processing system for creating and maintaining an online wizard, comprises the step of processing an HTML page. A HTML page designer designs an HTML page for the wizard by adding form fields and certain markers to enable the automatic generation of the wizard. A marker can be an attribute of the form field; for example, a marker to indicate that the form field should be validated to be a valid date is the attribute validator=“date”, and a marker to indicate a required field is the attribute isrequired=“1”. Some markers may work with another marker to specify further detail; for example, the attribute validator=“date” may work with the attribute format=“mm/dd/yyyy” to specify the required format of the date. FIG. 2 is a table of field/validator types and associated formats. FIG. 3 is a table of attributes for specifying further detail for a date validator type and the possible values of the attributes for the date validator type.

The system may process the HTML page when a request for the page is submitted to the system, for example, by using a web browser to invoke the page 102. Once the page is processed, the system automatically generates a user interface for data input based on the HTML page, wherein the user interface comprises a form field, and at least one field attribute for the form field. The user interface is generated to present information collection forms to a user and to collect user-inputted data in response to the forms. In some embodiments, the user interface comprises two or more form fields and the associated field attributes for such form fields. The method further comprises receiving the data inputted via the user interface, identifying, in the received data, the form field, and determining the type of form field received. See FIG. 2 for a table of some example types of form fields/validators.

The user interface may further comprise client-side validators, such as JavaScript validators 118, and/or server-based validator, such as AJAX validators 120. Validators can ensure that formatting and other requirements of a form field are met when the user provides data for the form field. JavaScript validators run on the client-side (browsers), while AJAX validators are triggered on the client-side to call the server-side to verify requirements. The system automatically determines the appropriate validators to apply to data entered in the form field based on the field attributes for the form field. A validator can monitor key presses to block the input of inappropriate values based on the at least one field attribute. Based on the at least one field attribute, a validator can also generate at least one response to the user about the user-entered data in the form field. The responses can inform the user of errors and requirements of the form field, and include Required and Correct format; Not Required; Incorrect Format; and Required.

In another embodiment, a processing system automates database operations for creating and maintaining an online wizard. A HTML page designer designs a page for a user to input data. The system processes the HTML page, where the page comprises a hidden input table field, a hidden input key field, and a hidden input ID field. The system then automatically generates a user interface for data input based on the HTML page, the user interface comprising the hidden input fields of the HTML page, a form field, and at least one field attribute for the form field. The system then receives the collected data; identifies, in the received data, the form field; and determines the type of form field received. The received collected data also includes the hidden input fields from the user interface. The system then determines 122 whether the hidden input table field in the received data corresponds to an existing table in a database, and automatically generates at least one command to operate on the database based on the hidden input fields in received data. If the hidden input table field does not correspond to any existing table in the database, then the command generated comprises an instruction to create 124 in the database a new table that corresponds to the hidden input table field, and an instruction to add to the newly created table a column that corresponds to the form field in the received data 126, 128.

If, on the other hand, the hidden input table field in the received data corresponds to an existing table in the database, the system then determines 126 whether the form field in the received data corresponds to an existing column in the database table. If the form field in the received data does not correspond to any existing column in the database table, then the command generated comprises an instruction to add to the database table 128 a column corresponding to the form field in the received data. But, if the form field in the received data corresponds to an existing column in the database table, then the system determines 132 whether the hidden input key field corresponds to an existing record in the database table—if it corresponds to an existing record in the database table, then the generated command comprises an instruction to update 136 the existing record based on the received data, and if it does not correspond to an existing record, then the generated command comprises an instruction to insert 134 a new record based on the received data.

Another embodiment is a method performed by a processing system for setting up a wizard module with save-and-return-to-complete ability. The method comprises creating a folder for a wizard on a storage medium, creating a plurality of HTML pages for the wizard, and storing those pages in the folder. The method further comprises creating a database table for the wizard, and automatically determining the progress of the wizard based on the names of the HTML pages. As one example, there may be ten pages named page01.htm, page02.htm, and so forth until page10.htm. If the current page of the wizard to be presented to the user is page04.htm, the method automatically determines that the progress is forty percent and may add a progress bar reflecting such determination to the page to be presented. In one embodiment, the name of the folder is based on the name of the database table, so that if the name of the table is “tb1”, then the name of the folder is “tb1” or “tb1_wiz”.

When the database table is created, the method may further automatically generate a primary key field for the database, where the name of the primary key field is based on the name of the database table. For example, if the name of the table is “tb1”, the name of the primary key field can be “tb1_pk1”. Also, when the database table is created, the method may further automatically generate a foreign key field for the database, where the name of the foreign key field is based on the name of the database table. For example, if the name of the table is “tb1”, the name of the foreign key field can be “tb1_fk1”.

The method further comprises determining the order or sequence for presenting the HTML pages based on the names of the pages, determining proper navigational elements for an HTML page to be presented based on the names of the HTML pages, and may further comprise receiving user-inputted data in response to each of the HTML pages presented. In an example of ten pages named page01.htm, page02.htm, and so forth until page10.htm, the pages are presented in order of the numeric suffix—01, 02, 03, etc., until 10. If the current page to be presented is named page04.htm, for example, then navigational elements, such as “Next” and “Previous” buttons, are configured to link to the pages named page04.htm and page03.htm, respectively. The configured navigational elements are added to the current page to be presented.

Similarly, the method further comprises determining whether the progress of the wizard is at the first or at the last page based on the names of the HTML pages and the number of total HTML pages in the folder. In an example where the wizard has ten pages named page01.htm, page02.htm, and so forth until page10.htm, if the current page is page01.htm or page10.htm, then the progress of the wizard is determined to be at the first page or last page of the wizard, respectively. The navigational elements are automatically determined and added to those pages such that the first page has, for example, a “Next” link and no “Previous” link, while the last page has, for example, a “Previous” link and no “Next” link. A navigational element of a “Finish” link, for example, may be automatically added to the last page to allow a user to indicate intent to leave the data entry. Alternatively, the “Finish” link element may be automatically added to each page, enabling a user to leave the data entry from each HTML page.

In one embodiment, when the user indicates intent to leave the data entry by activating, for example, a “Finish” link, the method further comprises generating a review HTML page that comprises a display of the summary of the information presented by the plurality of HTML pages and the user-inputted data in response to the presented information. The review page may further comprise navigational elements that enable the user to navigate to any of the plurality of HTML pages, and a navigational element that enables the user to indicate intent to exit the wizard. Such a review page, for example, enables a user to view the prompts presented to the user in the plurality of the HTML pages and all of the data that the user entered in response to the prompts.

In an embodiment, whenever the user activates any navigational element on an HTML page, such as a “Next” button or a “Finish” link, the user-inputted data is received by the processing system, and the method further comprises processing that data. Upon such processing, the method may further comprise determining, based on information in the received data, the correct database table to store the received data. The processing system may further determine if a data entry is a new record or an update to an existing record based on the information in the received data, and may further create database commands to insert a record or update a record, respectively.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A method performed by a processing system for creating and maintaining an online wizard, the method comprising the steps of:
processing an HTML page;
automatically generating a user interface for data input based on the HTML page, wherein the user interface comprises: a form field, and at least one field attribute for the form field;
receiving user-inputted data via the user interface;
identifying the form field in the received data; and
determining the type of form field received.

2. The method of claim 1, wherein the automatically generated user interface further comprises at least one of JavaScript validator and AJAX validator.

3. The method of claim 1, further comprising at creating, based on the received data, at least one of a database table creation instruction, server-side code, and database query code.

4. The method of claim 1, wherein the type of form field is selected from the group comprising:
Date
Time
Date Time
Zip Code
Phone Number
Email
URL (Uniform Resource Locator)
integer
credit card
bank account number
routing number
none
custom
currency
decimal
SSN (Social Security Number)
EIN (Employer Identification Number)
IP (Internet Protocol) address
Multi Select (checkboxes)
Text Area for large input
HTML input for formatted text
Single Select (radio buttons)
Single Select (list)
Single Select Binary
Un-ordered free form lists (array generation)
Required unique (AJAX)

5. The method of claim 1, further comprising automatically generating at least one response to the user based on the at least one field attribute, wherein each response to the user is selected from the group comprising:
Required and Correct format
Not Required
Incorrect Format
Required.

6. The method of claim 2, further comprising determining a JavaScript validator applicable to the form field based on the at least one field attribute.

7. The method of claim 6, further comprising determining an AJAX validator applicable to the form field based on the at least one field attribute.

8. The method of claim 6, wherein the determined JavaScript validator monitors key presses to block the input of inappropriate values based on the at least one field attribute.

9. The method of claim 8, wherein the determined JavaScript validator automatically corrects the format of the data in form field based on the at least one field attribute.

10. A method performed by a processing system to automate database operations for creating and maintaining an online wizard with save-and-return-to-complete capability, the method comprising the steps of:
processing an HTML page, the page comprising a hidden input table field, a hidden input key field, and a hidden input ID field;
automatically generating a user interface for data input based on the HTML page, the user interface comprising: the hidden input fields of the HTML page, a form field, and at least one field attribute for the form field;
receiving user-inputted data via the user interface;
identifying the form field in the received data;
determining the type of form field received;
determining whether the hidden input table field in the received data corresponds to an existing table in a database; and
automatically generating at least one command to operate on the database based on the hidden input fields in received data.

11. The method of claim 10, wherein the hidden input table field in the received data does not correspond to any existing table in the database, and the at least one command comprises:
an instruction to create in the database a new table that corresponds to the hidden input table field, and an instruction to add to the newly created table a column that corresponds to the form field in the received data.

12. The method of claim 10, wherein the hidden input table field in the received data corresponds to an existing table in the database, the method further comprising:
determining whether the form field in the received data corresponds to an existing column in the database table.

13. The method of claim 12, wherein the form field in the received data does not correspond to any existing column in the database table, and the at least one command comprises an instruction to add to the database table a column corresponding to the form field in the received data.

14. The method of claim 12, wherein the form field in the received data corresponds to an existing column in the database table, the method further comprising:
determining whether the hidden input key field corresponds to an existing record in the database table.

15. The method of claim 14, wherein the hidden input key field corresponds to an existing record in the database table, and the at least one command comprises an instruction to update the existing record based on the received data.

16. The method of claim 14, wherein the hidden input key field does not correspond to any existing record in the database table, and the at least one command comprises an instruction to create a new record based on the received data.

17. A method performed by a processing system, for setting up a wizard module with save-and-return-to-complete ability, comprising:
creating a folder for a wizard on a storage medium;
creating a plurality of HTML pages for the wizard;
storing the HTML pages in the folder;
creating a database table for the wizard; and
automatically determining a progress of the wizard based on the names of the HTML pages.

18. The method of claim 17, further comprising:
automatically generating a primary key field and a foreign key field for the database table when the table is created; and
naming both the primary key field and the foreign key field based on the name of the database table.

19. The method of claim 17, further comprising naming the folder based on the name of the database table.

20. The method of claim 17, further comprising:
determining the sequence for presenting the HTML pages based on the names of the pages;
determining proper navigational elements for an HTML page to be presented based on the names of the HTML pages;
adding the determined navigational elements to the HTML page to be presented; and
presenting the HTML pages in the determined sequence to a user.

21. The method of claim 20, further comprising receiving user-inputted data in response to the presented HTML pages.

22. The method of claim 20, further comprising assigning the HTML pages names that comprise a numeric suffix appended to a sequence of at least one alphabet letter, and wherein: the sequence of at least one alphabet letter is the same for every HTML file in the folder, and the numeric suffix, to indicate the sequence to present the pages, is different for each HTML file in the folder.

23. The method of claim 20, further comprising determining whether the progress of the wizard is at the first or at the last page based on the names of the HTML pages and the number of total HTML pages in the folder.

24. The method of claim 23, further comprising generating a review HTML page comprising the summary of the information presented by the plurality of HTML pages and the user-inputted data in response to the presented information.

25. The method of claim 24, wherein the review HTML page further comprises navigational elements that enable the user to navigate to any of the plurality of HTML pages.

26. The method of claim 25, wherein the review HTML page further comprises a navigational element that enables the user to indicate an intent to exit the wizard.

27. The method of claim 21, further comprising processing the user inputted-data upon the activation of a navigational element by a user.

28. The method of claim 21, wherein each presented HTML page further comprises a form field and at least one field attribute for the form field, the method further comprising determining a JavaScript validator applicable to the form field based on the at least one field attribute.

29. The method of claim 21, further comprising determining, based on information in the received data, the database table to store the received data.

30. The method of claim 17, wherein the processing system determines if a data entry is a new record or an update to an existing record based on the combination of those items.

31. The method of claim 30, wherein if the data entry is an update to an existing record, an update command is created.

32. The method of claim 30, wherein if the data entry is a new record, an insert command is created.

33. A method performed by a processing system for retaining data for returning users in an online wizard with save-and-return-to-complete ability, the method comprising the steps of:
creating an HTML page;
automatically generating a user-interface, validators, navigational elements, database table creation instructions, server-side code, and database query code based on the HTML page;
presenting the user interface to a user;
receiving user-inputted data via a user interface;
storing the received data in a database table based on information in the received data;
maintaining the user's progress in the wizard in the database table; and
presenting to the user the furthest page attempted by the user when the user returns to the wizard.

34. The method of claim 33 further comprising, automatically inserting previously inputted data stored in the database into the HTML to be presented to the user.

35. A system for creating and maintaining an online wizard with save-and-return-to-complete ability comprising:
a computing device comprising a processor coupled to a computer readable storage medium including a computer executable instructions that when executed by the processor perform a method comprising:
creating at least one HTML page;
automatically generating a user-interface, validators, navigational elements, database table creation instructions, server-side code, and database query code based on the at least one HTML markup page;
automatically generating database commands based on information in the at least one HTML page;
setting up a wizard module, each wizard having its own folder on the storage medium, and the folder containing the at least one HTML page of the wizard;
establishing a review and completion process in the final page of the wizard module; and
establishing data retention capability for returning users.
